(19) United States
(12) Patent Application Publication
(10) Pub. No.: US 2003/0017370 A1
(43) Pub. Date: Jan. 23, 2003

(54) Magnetic recording medium, method of manufacturing therefor and magnetic replay apparatus

(75) Inventors: Kanji Shimizu, Ichihara-shi (JP); Akira Sakawaki, Ichihara-shi (JP); Hiroshi Sakai, Ichihara-shi (JP); Futoshi Nakamura, Ichikawa-shi (JP); Takashi Hikosaka, Tokyo (JP)

Correspondence Address: SUGHRUE MION, PLLC, 2100 PENNSYLVANIA AVENUE, N.W., WASHINGTON, DC, 20037, US

(73) Assignee: SHOWA DENKO K.K.

(21) Appl. No.: 10/151,896

(22) Filed: May 22, 2002

Related U.S. Application Data
(60) Provisional application No. 60/295,819, filed on Jun. 6, 2001.

(30) Foreign Application Priority Data
May 23, 2001 (JP) P2001-154449

(51) Int. Cl. G11B 5/667

(52) U.S. Cl. 428/694 TM

(57) ABSTRACT

The present invention provides a magnetic recording medium that does not cause a deterioration of the noise characteristics and improves the production efficiency, a manufacturing method for the same, and a magnetic recording replay apparatus. An in-plane undercoat film 2 and an in-plane hard magnetic film 3 whose axis of easy magnetization is generally oriented in the in-plane direction are formed between the non-magnetic substrate 1 and the soft magnetic film 4, the in-plane undercoat film 2 comprises Cr or a Cr alloy, and the in-plane hard magnetic film 3 has as the major constituent a CoCrPtX alloy (where X is one or more of B, Ta, Cu, Zr, Nb, Re, Ni, Mn, Ge, Si, O, and N).

### CROSS REFERENCE TO RELATED APPLICATIONS

The present application is filed under 35 U.S.C. § 111(a), and claims benefit, pursuant to 35 U.S.C. § 119(e)(1), of the filing dates of Provisional Application No. 60/295,819 filed Jun. 6, 2001, pursuant to 35 U.S.C. § 111(b).

### BACKGROUND OF THE INVENTION

1. Field of the Invention

The present invention relates to a magnetic recording medium, a method of manufacturing therefor, and a magnetic replay apparatus that uses this magnetic recording medium.

2. Description of the Related Art

A perpendicular magnetic recording medium, in which the axis of easy magnetization within the magnetic film is oriented generally perpendicular to the substrate, have received a great deal of attention because the effect of the demagnetizing field at the bit boundaries is small even when high recording density has been realized, and it is possible to improve thermal stability characteristics and noise reduction due to the formation of magnetic recording domains which have distinct boundaries.

In recent years, a magnetic recording medium has been proposed wherein a soft magnetic undercoat film (what is termed a backing film) comprising a soft magnetic material between the substrate and the perpendicular magnetic film, and the efficiency of the flow of the magnetic flux between the magnetic head and the magnetic recording medium is improved.

The soft magnetic undercoat film has formed thereon extremely large magnetic domains having a small coercive force and an easily changeable direction of magnetization. The magnetic wall at the boundary of the magnetic domain is a cause of the occurrence of spike noise.

Thus, to prevent the occurrence of spike noise due to the formation of these magnetic domains, there have been investigations of providing a hard magnetic film comprising a hard magnetizing material between the substrate and the soft magnetic undercoat film, forcing the magnetic direction of the soft magnetic undercoat film to face the radial direction of the substrate by the magnetic exchange coupling between this hard magnetic film and the soft magnetic undercoat film.

Japanese Unexamined Patent Application, First Publication, No. Hei 5-277687 discloses a magnetic recording medium providing such a hard magnetic film.

The magnetic recording medium disclosed in this publication provides an in-plane permanent magnetic film comprising an SmCo alloy or CoCrTa. The thickness of the soft magnetic undercoat film is, for example, 25 to 200 nm. In this magnetic recording medium, the occurrence of noise described above can be prevented by this in-plane permanent magnetic film.

In the manufacture of a magnetic recording medium, usually a sputtering method is used on the film.

Because the film formation speed is low compared to other film formation methods, a sputtering method is a method with a production efficiency that easily becomes low.

In the conventional magnetic recording medium described above, improvements in the production efficiency can be implemented by forming a thin soft magnetic undercoat film, but in this case, there is the problem that the noise characteristics of the obtained magnetic recording medium deteriorate due to the noise from the in-plane permanent magnetic film provided under the soft magnetic undercoat film.

In consideration of the problems above described, it is an object of the present invention to provide a magnetic recording medium that can improve the production efficiency without the noise characteristics deteriorating, a manufacturing method for the same, and a magnetic recording replay apparatus.

### SUMMARY OF THE INVENTION

The present inventors have discovered that the problem of noise characteristic deterioration that occurs during the formation of a thin soft magnetic undercoat film is due to the noise caused by the hard magnetic film. The deterioration of the noise characteristics due to the soft magnetic undercoat film being made thinner is caused by an increase in the noise that originates in the hard magnetic film, which is due to the distance between the magnetic head and the hard magnetic film becoming small during replay. The present invention has been completed based on this insight.

Specifically, the magnetic recording medium of the present invention forms an in-plane undercoat film and an in-plane hard magnetic film whose soft magnetic axis generally faces the in-plane direction are formed between a non-magnetic substrate and a soft magnetic undercoat film. The in-plane undercoat film comprises Cr or a Cr alloy, and the in-plane hard magnetic film comprises a CoCrPtX alloy (where X is one or more of B, Ta, Cu, Zr, Nb, Re, Ni, Mn, Ge, Si, O, or N).

The magnetic recovery factor of the soft magnetic undercoat film is preferably equal to or greater than 0.85.

The coercive force to squareness ratio S* of the in-plane soft magnetic film is preferably equal to or greater than 0.6.

In the magnetic recording medium of the present invention, the coercive force Hc of the in-plane hard magnetic film is equal to or greater than 100 (Oe), the saturation magnetization is equal to or greater than 200 (memu/cm³) and less than 600 (memu/cm³), and the thickness is preferably equal to or greater than 10 nm and less than 100 nm.

The thickness of the soft magnetic undercoat film is preferably 50 to 200 nm.

In the manufacturing method for the magnetic recording medium of the present invention, an in-plane undercoat film is provided between the non-magnetic substrate and a soft magnetic undercoat film, and an in-plane hard magnetic film whose soft magnetic axis generally faces the in-plane direction is provided thereon. The in-plane undercoat film comprises Cr or a Cr alloy, and the in-plane hard magnetic film comprises a CoCrPtX alloy (where X is one or more of B, Ta, Cu, Zr, Nb, Re, Ni, Mn, Ge, Si, O, or N).

The magnetic recording replay apparatus of the present invention provides a magnetic recording medium and a magnetic head that replays the information on this magnetic recording medium. In the magnetic recording medium, an in-plane undercoat film and an in-plane hard magnetic film whose soft magnetizing axis generally faces the in-plane direction are formed between a non-magnetic substrate and a soft magnetic undercoat film. The in-plane undercoat film comprises Cr or a Cr alloy, and the in-plane hard magnetic film comprises a CoCrPtX alloy (where X is one or more of B, Ta, Cu, Zr, Nb, Re, Ni, Mn, Ge, Si, O, or N).

### BRIEF DESCRIPTION OF THE DRAWINGS

FIG. 1 is a partial cross-sectional drawing showing a first embodiment of the magnetic recording medium of the present invention.

FIG. 2 is an explanatory drawing for explaining the magnetic recovery factor.

FIG. 3 is a partial cross-sectional drawing showing a second embodiment of the magnetic recording medium of the present invention.

FIG. 4 is a partial cross-sectional drawing showing a third embodiment of the magnetic recording medium of the present invention.

FIG. 5 is a partial cross-sectional drawing showing a fourth embodiment of the magnetic recording medium of the present invention.

FIG. 6 is a partial cross-sectional drawing showing a fifth embodiment of the magnetic recording medium of the present invention.

FIG. 7 is a partial cross-sectional drawing showing a sixth embodiment of the magnetic recording medium of the present invention.

FIG. 8 is a schematic structural drawing showing an embodiment of the magnetic recording replay apparatus of the present invention.

FIG. 9 is a structural drawing showing an example of the magnetic head used in the magnetic recording replay apparatus shown in FIG. 8.

### DETAILED DESCRIPTION OF THE INVENTION

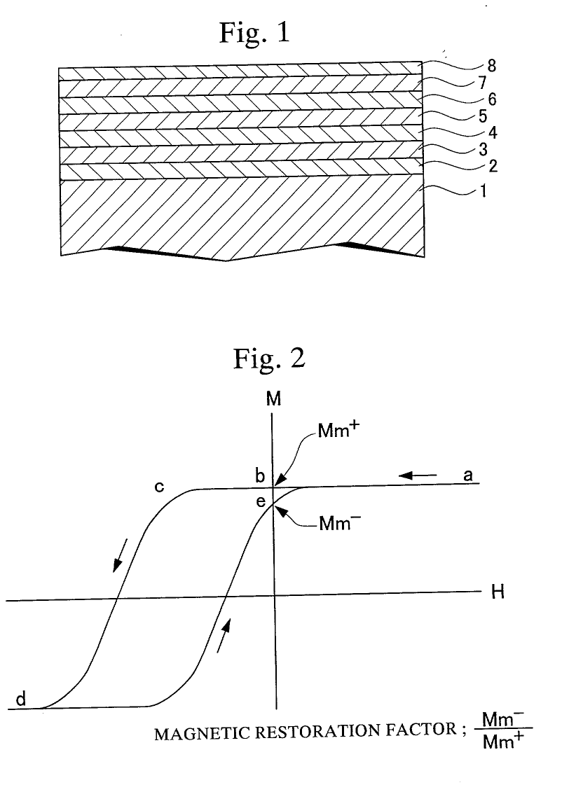

FIG. 1 shows the first embodiment of the invention. The magnetic recording medium shown here has a structure in which the in-plane undercoat film 2, the in-plane hard magnetic film 3, the soft magnetic undercoat film 4, the orientation control film 5, the perpendicular magnetic film 6, the protective film 7, and the lubrication film 8 have been formed successively on a non-magnetic substrate 1.

Examples of the non-magnetic substrate 1 are aluminum alloy substrates, glass substrates (crystallized glass, reinforced glass, and the like), ceramic substrates, carbon substrates, silicon substrates, and silicon carbide substrates that have a NiP plating generally used as a magnetic recording medium substrate. In addition, examples of substrates can be given in which the NiP film is formed on these substrates by a plating method, sputtering method, or the like.

The mean surface roughness Ra of the substrate 1 is preferably 0.01 to 2 nm (more preferably 0.05 to 1.5 nm).

When the mean surface roughness Ra falls below this range, adhesion of the magnetic head to the medium and magnetic head vibration during replay occur easily. In addition, when the mean surface roughness Ra exceeds this range, the glide characteristics easily become insufficient.

The in-plane undercoat film 2 is for increasing the crystal orientation of the in-plane hard magnetic film 3 that is positioned directly thereon, and thus Cr or a Cr alloy is used.

Examples of Cr alloys used in the in-plane undercoat film 2 are CrMo, CrTi, CrW, CrMo, CrV, CrSi, and CrNb alloys.

The content of the Cr in these Cr alloys is preferably equal to or greater than 60 at % (more preferably equal to or greater than 75 at %). When the Cr content falls below this range, the crystal orientation of the in-plane hard magnetic film 3 deteriorates, and the magnetic characteristics such as coercive force decrease in the in-plane hard magnetic film 3.

The thickness of this in-plane undercoat layer 2 is preferably 1 to 1000 nm (more preferably 2 to 50 nm).

The in-plane hard magnetic film 3 is for suppressing magnetic domain formation in the soft magnetic undercoat layer 4 and preventing the occurrence of spike noise, and thus is a magnetic film in which the axis of easy magnetization is generally oriented in the in-plane direction (the direction along the substrate surface).

In the magnetic recording medium of the present embodiment, the in-plane hard magnetic film 3 comprises a CoCrPtC alloy (where X is one or more of B, Ta, Cu, Zr, Nb, Re, Ni, Mn, Ge, Si, O, or N).

In particular, preferably the CoCrPtX alloy is the main constituent. Moreover, the term “main constituent” denotes the constituent included so as to exceed 50 at %.

Preferably CoCrPtB alloy, CoCrPtTa alloy, or CoCrPtBCu alloy are included as CoCrPtX alloys.

In the in-plane hard magnetic film 3, preferably the Cr is incorporated at 10 to 26%, the Pt at 1 to 16 at %, and X at 0.5 to 10 at %, and the remainder is CoCrPtX substantially comprising Co.

The reason for preferably maintaining the Cr content within the above range is that when the content falls below this range the Cr segregation in the magnetic films occurs with difficulty and the scattering of magnetic particles is insufficient, and thereby noise increases. When this range is exceeded, the coercive force Hc decreases.

The reason for preferably maintaining the Pt content within the above range is that when the content falls below this range, the coercive force Hc becomes low, and when this range is exceeded, there is a tendency for the noise to become large.

The reason for preferably maintaining the X content within the above range is that when the content falls below this range, there is a tendency for the noise to increase, and when this range is exceeded, the coercive force Hc becomes low.

The coercive force to squareness ratio S* of the in-plane hard magnetic film 3 is preferably equal to or greater than 0.6 (more preferably equal to or greater then 0.7).

When the coercive force to squareness ratio S* falls below this range, the magnetic recovery factor of the soft magnetic undercoat film 4 decreases.

The coercive force Hc of the in-plane hard magnetic film 3 is preferably equal to or greater than 1000 (Oe) (more preferably equal to or greater than 2000(Oe)).

When the coercive force Hc falls below this range, the in-plane hard magnetic film 3 is easily subject to magnetic reversal due to external magnetic fields, and the spike noise increases.

The saturation magnetization Ms of the in-plane hard magnetic film 3 is preferably equal to or greater than 200 memu/cm³, and less than 600 memu/cm³ (more preferably 300 to 500 memu/cm³).

When the saturation magnetization Ms is less than this range, the coupling magnetic field of the soft magnetic undercoat film 4 and the in-plane hard magnetic film 3 becomes small, and spike noise occurs easily. In addition, the noise due to magnetic fluctuation of the surface side of the soft magnetic undercoat film 4 increases. In addition, when the saturation magnetization Ms exceeds this range, noise originating in the in-plane hard magnetic film 3 increases.

The thickness of the in-plane hard magnetic film 3 is preferably equal to or greater than 10 nm, and less than 100 nm (more preferably 45 to 80 mm). When the thickness falls below this range, the coupling magnetic field of the soft magnetic undercoat film 4 and the in-plane hard magnetic film 3 becomes small and the spike noise occurs easily. In addition, when the thickness exceeds this range, the noise originating in the in-plane hard magnetic film 3 increases.

The soft magnetic undercoat film 4 is provided in order to establish more firmly the magnetization of the perpendicular magnetic film 6, which records the information, in a direction perpendicular to the substrate 1.

An Fe alloy having an Fe content equal to or greater than 60 at % can be used as the soft magnetic material that forms the soft magnetic undercoat film 4. Examples of this material include FeCo alloys (FeCo, FeCoV and the like), FeNi alloys (FeNi, FeNiMo, FeNiCr, FeNiSi and the like), FeAl alloys (FeAl, FeAlSi, FeAlSiCr, FeAlSiTiRu and the like), FeCr alloys (FeCr, FeCrTi, FeCrCu and the like), FeTa alloys (FeTa, FeTaC and the like), FeC alloys, FeN alloys, FeSi alloys, FeP alloys, FeNb alloys, and FeHf alloys.

The soft magnetic undercoat film 4 can be structured by microcrystals comprising FeAlO, FeMgO, FeTaN, FeZrN or the like. In addition, it can also have a granular structure in which the microcrystals are dispersed in a matrix.

The Co content of the soft magnetic undercoat film 4 is equal to or greater than 80 at %, and a Co alloy incorporating at least one or more of Zr, Nb, Ta, Cr, Mo or the like can be used. For example, CoZr, CoZrNb, CoZrTa, CoZrCr, and CoZrMo can be used advantageously.

In addition, the soft magnetic undercoat film 4 may comprise an alloy having an amorphous structure.

The magnetic recovery factor of the soft magnetic undercoat film 4 is preferably set equal to or greater than 0.85 (more preferably equal to or greater than 0.9). When the magnetic recovery factor falls below this range, noise increases due to magnetic domain formation within the soft magnetic undercoat film 4.

This magnetic recovery factor will be explained below.

As shown in FIG. 2, on the hysteresis curve, Mm⁺ denotes the magnetization from the state in which the magnetization is saturated (the position indicated by reference symbol a) to the position b, where, during the process of decreasing the external magnetic field, the external magnetic field becomes 0.

When the external magnetic field is further decreased, at the position indicated by reference symbol c, the rate of magnetic decrease of the soft magnetic undercoat film 4 becomes high, and at the position indicated by reference symbol d, the magnetization of the soft magnetic undercoat film 4 is completely reversed (magnetic reversal position). At this position, the magnetization of the in-plane hard magnetic film 3 is not yet completely reversed.

Mm⁻ denotes the magnetization where the external magnetic field is increased from this state to 0 (the position indicated by reference symbol e).

The magnetic recovery factor can be represented by Mm⁻/Mm⁺.

In addition, when measuring the magnetic recovery factor, the magnetic reversal position d is considered to be the position at which the external magnetic field becomes −100 (Oe), and Mm⁻/Mm⁺ can be measured by decreasing the external magnetic field from the magnetic saturation position a to −100 (Oe), and then increasing the external magnetic field to 0 (Oe).

The saturation magnetic flux density Bs of the soft magnetic undercoat film 4 is preferably equal to or greater than 1T (more preferably, equal to or greater than 1.4 T). When the saturation magnetic flux density Bs falls below this range, the control of the replay waveform becomes difficult, the film must be made thick, and this invites lowering of the production efficiency.

The coercive force of the soft magnetic undercoat film 4 is preferably equal to or less than 200 (Oe) (15.8×10³ A/m). When the coercive force falls below this range, the efficiency of the flow of the magnetic flux in the closed magnetic circuit formed between the magnetic head and the soft magnetic undercoat film 4 decreases, and thereby the recording characteristics deteriorate.

The thickness of the soft magnetic undercoat film 4 can be set at 50 to 200 nm. When the thickness falls below this range, the efficiency of the flow of the magnetic flux in the closed magnetic circuit formed between the magnetic head and the soft magnetic undercoat film 4 decreases, and thereby the recording characteristics deteriorate. When the thickness exceeds this range, a long time is necessary for the film formation, and this invites a reduction in production efficiency.

The thickness of the soft magnetic undercoat film 4 can be appropriately set depending on the saturation magnetic density of the material that forms the soft magnetic undercoat film 4.

Specifically, Bs·t, which is the product of the saturation magnetic density Bs of the material that forms the soft magnetic undercoat film 4 and the film thickness t of the soft magnetic undercoat film 4, is preferably equal to or greater than 50 T·nm (more preferably equal to or greater than 100 T·nm).

When this Bs-t falls below this range, the efficiency of the flow of the magnetic flux in the closed magnetic circuit formed between the magnetic had and the soft magnetic undercoat film 4 decreases, and thereby the recording characteristics deteriorate.

The Bs·t is preferably 100 to 300 T·nm. In the case that the Bs·t is set at a value that exceeds this range, the film must be made thick, and the productive efficiency decreases.

The soft magnetic undercoat film 4 can be formed such that the constituent material in the surface (the surface on the orientation control film 5 side) is partially or completely oxidized.

The thickness of this oxidized portion (oxidized film) is preferably equal to or greater than 0.1 nm and less than 3 nm.

The condition of oxidation of the soft magnetic undercoat film 4 can be confirmed by Auger electronic spectroscopy, SIMS, or the like. The thickness of the oxidized portion (oxidized film) of the surface of the soft magnetic undercoat film 4 can be found, for example, by a transmission electron microscope (TEM) photograph of a cross-section of the medium.

The orientation control film 5 is a film provided for controlling the orientation and crystal particle diameter of the perpendicular magnetic film 6, which is positioned directly thereon.

An hcp structure or an fcc structure are examples of the material for the orientation control film 5.

Examples of materials that have an hcp structure include those having a content equal to or greater than 50 at % of one or more of Ti, Zn, Y, Zr, Ru, Re, Gd, Tb, or Hf. Specific examples are RuCr, HfB, HfCo, HfCr, ErC, Ru—SiO₂, Hf—SiO₂, and Hf—Al₂O₃.

Examples of materials that have an fcc structure include those having a content equal to or greater than 50 at % of one or more of Ni, Cu, Pd, Ag, Pt, Ir, Au, or Al. Specific examples are NiCrN, PdB, PdCr, AgCo, Ir—SiO₂, Al—Al₂O₃.

The thickness of the orientation control film 5 is preferably equal to or less than 100 nm (more preferably equal to or les than 50 nm).

When the film thickness exceeds this range, the diameter or the crystal particles in the orientation control film 5 become large, and the magnetized particles in the perpendicular magnetic film 6 can easily become coarse. In addition, the distance between the magnetic head and the soft magnetic undercoat film 4 becomes large during replay, and the resolution of the replay signal decreases and the noise characteristics deteriorate, which is not preferable.

The orientation control film 5 is preferably formed so that its thickness is equal to or greater than 2 nm because if it is too thin, the crystal orientation of the perpendicular magnetic film 6 deteriorates, and the replay characteristics deteriorate.

The perpendicular magnetic film 6 is a magnetic film whose axis of easy magnetization is generally oriented perpendicular to the substrate, and using a Co alloy in the perpendicular magnetic film 6 is preferable.

Examples of a Co alloy are CoCrPt alloy and CoPt alloy. These alloys can be doped with at least one element selected from among Ta, Zr, Nb, Cu, Re, Ru, V, Ni, Mn, Ge, Si, B, O, N, or the like.

In addition, a material that has a non-crystalline structure, such as a rare earth element alloy like a TbFeCo alloy, can be used on the perpendicular magnetic film 6.

The perpendicular magnetic film 6 can be can have a single layer structure that is uniform in the thickness direction, or can have a multiple layer structure in which a layer comprising a transition metal (Co, Co alloy) and a layer comprising a noble metal (Pt, Pd, or the like) are laminated. In the transition metal layer, Co can also be used, or a Co alloy such as CoCrPt alloy, CoPt alloy or the like can be used.

The thickness of the perpendicular magnetic film 6 can be appropriately optimized according to the target replay output, but in the case of either a single layer structure or a multiple layer structure, in the case that the perpendicular magnetic film 6 is too thick, problems such as the deterioration of noise characteristics and a decrease in resolution occur easily, and thus the thickness is preferably equal to or greater than 100 nm (more preferably 3 to 100 nm).

In addition, the reverse magnetic domain nucleation field of the perpendicular magnetic film 4 is preferably equal to or greater than 0 (Oe). When the reverse magnetic domain nucleation field falls below this range, the thermal stability resistance decreases.

The reverse magnetic domain nucleation field is the numerical value represented by the distance (Oe) from the point at which the external magnetic field becomes 0 (for example, the position indicated by the reference symbol b in FIG. 2) to the point at which the rate of magnetization decrease rapidly becomes high (for example, the position indicated by reference symbol c in FIG. 2) in the process of the magnetization decreasing from a saturated state.

Moreover, the reverse magnetic domain nucleation field takes a positive value in the case that the point at which the rate of magnetization decreases rapidly becomes high is in a region in which the external magnetic field becomes negative, and contrariwise, takes a negative value in the case that this point is in a region in which the external magnetic field becomes positive.

The protective film 7 is for preventing corrosion of the perpendicular magnetic film 6, and at the same time, prevents damage to the medium surface when the magnetic head comes into contact with the medium, and preserves the lubricating characteristics between the magnetic head and the medium. Conventionally well-known materials can be used. For example, a composition of only C, SiO₂, or ZrO₂ or one that uses these as the main constituent while incorporating other elements can be used.

The thickness of the protective film 7 is preferably in a range of 1 to 10 nm.

A well-known lubricant such as perfluoropolyether, fluorinated alcohol, fluorinated carboxylic acid, or the like can be used in the lubrication film 8. The type and thickness can be appropriately set depending on the protective film and the lubricant that are used.

In the manufacture of the magnetic recording medium having the structure described above, the in-plane undercoat film 2, the in-plane hard magnetic film 3, and the soft magnetic undercoat film 4 are formed on the substrate 1 shown in FIG. 1 by a sputtering method or the like, next an oxidizing treatment is carried out on the surface of the soft magnetic undercoat film 4 when necessary, and then the orientation control film 5, the perpendicular magnetic film 6, and the protective film 7 are formed in sequence by a sputtering method or the like.

Next, the lubrication film 8 is formed using a deep coating method or a spin coating method.

In the case that an oxidizing treatment is carried out on the surface of the soft magnetic undercoat film 4, after forming the soft magnetic undercoat film 4, a method in which the soft magnetic undercoat film 4 is exposed to a gas that includes oxygen or a method that introduces oxygen into the process gas when forming the portion of the film at the surface of the soft magnetic undercoat film 4 can be used.

Due to the surface oxidation of the soft magnetic undercoat film 4, the magnetic fluctuation of the surface of the soft magnetic undercoat film 4 can be suppressed, and the effect can be obtained wherein the noise characteristics are improved by making the crystal particles of the orientation control film 5 that is formed on the soft magnetic undercoat film 4 more fine.

Due to the oxidized portion (oxidized layer) of the surface of the soft magnetic undercoat film 4, the transfer of corrosive materials from the soft magnetic undercoat film 4 to the medium surface can be suppressed, and the occurrence of corrosion of the medium surface can be prevented.

As a formation method for the protective film 7, a sputtering method that uses a carbon target, a CVD method, or an ion beam method can be used.

In the case that the CVD method or the ion beam method is used, because a protective film 7 having an extremely high hardness can be formed, it can be made much thinner in comparison to a protective film formed by a sputtering method. Thus, the spacing loss during replay is small, and high-density replay can be carried out.

In the magnetic recording medium of the present embodiment, between the non-magnetic substrate 1 and the soft magnetic undercoat film 4, the in-plane undercoat film 2 and the in-plane hard magnetic film 3 are provided. Thus, magnetic exchange coupling is established between the in-plane hard magnetic film 3 and the soft magnetic undercoat film 4, and thereby the magnetic orientation of the soft magnetic undercoat film 4 can be forcibly made to align with the radial direction of the substrate.

Thus, magnetic domains are not formed in the soft magnetic undercoat film 4, and thereby the occurrence of spike noise can be prevented.

In this magnetic recording medium, the in-plane hard magnetic film 3 incorporates a CoCrPtX alloy (where X is one or more of B, Ta, Cu, Zr, Nb, Re, Ni, Mn, Ge, Si, O, or N), and thus in comparison to conventional products that have a hard magnetic film comprising an SmCo alloy, the crystal orientation in the in-plane direction of the in-plane hard magnetic film 3 is favorable, and at the same time the magnetic particles can be made finer.

Thereby, the occurrence of noise that originates in the in-plane hard magnetic film 3 can be greatly suppressed.

In addition, because the in-plane undercoat film 2 is provided, it is possible to further increase the crystal orientation of the in-plane hard magnetic film 3 in the in-plane direction, and at the same time, the magnetic particles can be made even finer. Thereby, the noise can be further reduced.

Thus, an increase in noise can be suppressed even in the case that the soft magnetic undercoat film 4 is formed so as to be thin.

Therefore, by forming the soft magnetic undercoat film 4 so as to be thin, the production efficiency can be increased, and superior noise characteristics can be obtained.

In addition, according to the manufacturing method described above, because the in-plane undercoat film 2 and the in-plane hard magnetic film 3 are provided between the non-magnetic substrate 1 and the soft magnetic undercoat film 4, the noise that originates in the in-plane hard magnetic film 3 can be suppressed.

Therefore, by forming the soft magnetic undercoat film 4 so as to be thin, the production efficiency can be increased, and superior noise characteristics can be obtained.

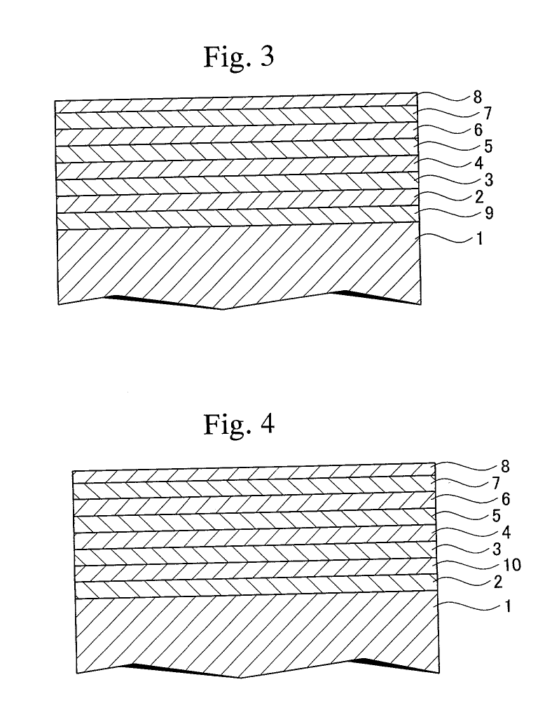

FIG. 3 is a drawing showing a second embodiment of the magnetic recording medium of the present invention. The magnetic recording medium shown here differs from the magnetic recording medium shown in FIG. 1 in that a seed film 9 is provided between the non-magnetic substrate 1 and the in-plane undercoat film 2.

This seed film 9 is for increasing the crystal orientation of the in-plane undercoat film 2 formed directly thereon, and thus, as a material therefore, one or more of NiAl, FeAl, CoFe, CoZr, NiTi, AlCo, AlRu, CoTi, and CrTa can be used as the main constituent.

In the present embodiment, by providing the seed film 9, the crystal orientation of the in-plane undercoat film 2 and the in-plane hard magnetic film 3 is increased, and the medium noise can be further suppressed.

FIG. 4 is a drawing showing a third embodiment of the magnetic recording medium of the present invention. The magnetic recording medium shown here differs from the magnetic recording medium shown in FIG. 1 in that the in-plane middle film 10 is provided between the in-plane undercoat film 2 and the in-plane hard magnetic film 3.

The in-plane middle film 10 is for increasing the crystal orientation of the in-plane hard magnetic film 3, and a nonmagnetic Co alloy can be used as the material.

An alloy comprising Co doped with one or more of Cr, Ta, Zr, Nb, Cu, Re, Ru, Ni, Mn, Ge, Si, O, N, and B can be used as this Co alloy.

Among these, a CoCr alloy is preferably used.

The thickness of the in-plane middle film 10 is preferably 1 to 20 nm.

In the present embodiment, by providing the in-plane middle film 10, the orientation in the in-plane hard magnetic film 3 can be improved, and the magnetic characteristics such as the coercive force Hc in the in-plane hard magnetic film 3 can be increased.

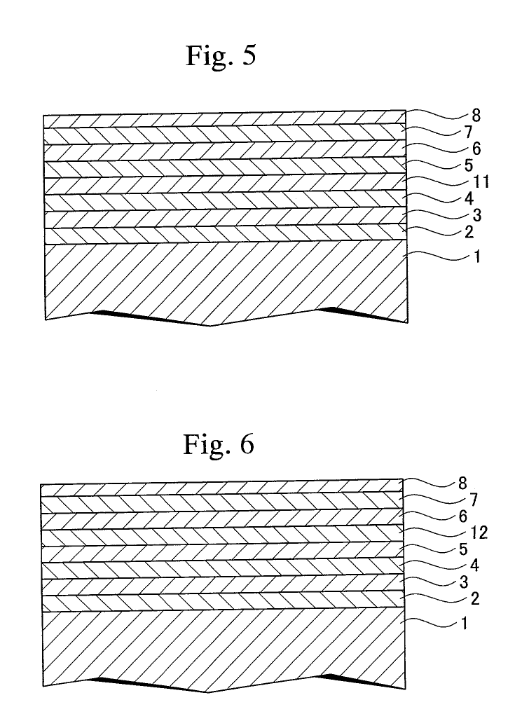

FIG. 5 is a drawing showing a fourth embodiment of the magnetic recording medium of the present invention. The magnetic recording medium shown here differs from the magnetic recording medium shown in FIG. 1 in that the orientation control undercoat film 11 is provided between the soft magnetic undercoat film 4 and the orientation control film 5.

The orientation control undercoat film 11 is for increasing the crystal orientation of the orientation control film 5, and a material having a B2 structure is preferably used.

An alloy having one or more of NiAl, FeAl, CoFe, CoZr, NiTi, AlCo, AlRu, and CoTi can be used as this material. In addition, a material comprising these alloys doped with elements such as Cr, Mo, Si, Mn, W, Nb, Ti, Zr, B, O, or N can be used.

The thickness of the orientation control undercoat film 11 is preferably equal to or less than 30 nm. When the thickness exceeds this range, the distance between the perpendicular magnetic film 6 and the soft magnetic undercoat film 4 becomes large, the resolution decreases, and the noise characteristics deteriorate. The thickness of the orientation control undercoat film 11 is preferably equal to or greater than 0.1 nm.

In the present embodiment, by providing the orientation control undercoat film 11, the orientation of the orientation control film 5 and the perpendicular magnetic film 6 can be increased, and the magnetic characteristics such as the coercive force Hc in the perpendicular magnetic film 6 can be increased.

FIG. 6 is a drawing showing the fifth embodiment of the present invention. The magnetic recording medium shown here differs from the magnetic recording medium shown in FIG. 1 in that the non-magnetic middle film 12 is provided between the orientation control film 5 and the perpendicular magnetic film 6.

The non-magnetic middle film 12 is for increasing the crystal orientation of the perpendicular magnetic film 6, and a non-magnetic Co alloy can be used as this material.

An alloy comprising the Co doped with one or more of Cr, Ta, Zr, Nb, Cu, Re, Ru, Ni, Mn, Ge, Si, O, N, or B can be used as this Co alloy.

Among these, in particular a CoCr alloy is preferably used.

The thickness of the non-magnetic middle film 12 is preferably equal to or less than 20 nm and more preferably equal to or less than 10 nm because when it is too thick, the distance between the perpendicular magnetic film 6 and the soft magnetic undercoat film 4 becomes large and thereby the resolution decreases and the noise characteristics deteriorate.

In the present embodiment, by providing the non-magnetic middle film 12, the orientation of the perpendicular magnetic film 6 can be improved, and the magnetic characteristics such as the coercive force Hc can be increased.

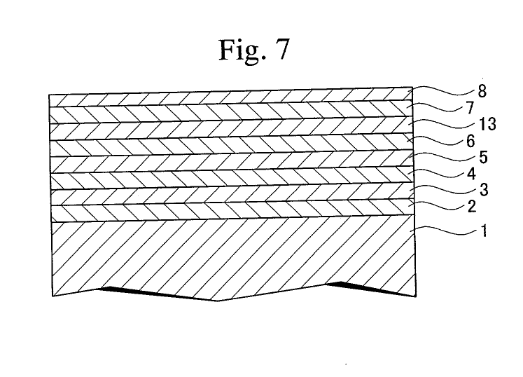

FIG. 7 is a drawing showing a sixth embodiment of the magnetic recording medium of the present invention. The magnetic recording medium shown here differs from the magnetic recording medium shown in FIG. 1 in that the magnetizing stabilization film 13 is provided between the perpendicular magnetic film 6 and the protective film 7.

The materials that were given as examples used in the soft magnetic undercoat film 4 can be used as the material for the magnetizing stabilization film 13.

The coercive force Hc of the magnetizing stabilization film 13 is preferably equal to or less than 200 (Oe) (more preferably 50 (Oe)).

The saturated magnetic flux density Bs of the magnetizing stabilization film 13 is preferably equal to or greater than 0.4 T (more preferably equal to or greater than 1 T).

In addition, the product of the saturation magnetic flux density and the film thickness Bs·t is preferably equal to or less than 7.2 T·nm. When this Bs·t exceeds this range, the replay output decreases.

The magnetizing stabilization film 13 can have a structure in which the constituent material in the surface is partially or completely oxidized. That is, in the surface of the magnetizing stabilization film 13 (the surface of the protective film 7 or the perpendicular magnetic film 6 side) and the proximity thereof (a region which is a predetermined depth from the surface), the structure is such that the constituent material is partially or completely oxidized.

In the present embodiment, by providing the magnetizing stabilization film 13, the fluctuation of the magnetization in the surface of the perpendicular magnetic film 6 can be suppressed.

Thereby, the leakage flux is not influenced by this fluctuation, and the replay output is increased.

In addition, by providing the magnetizing stabilization film 13, the magnetization of the perpendicular magnetic film 6 in the perpendicular direction and the magnetization of the soft magnetic undercoat film 4 and the magnetizing stabilization film 13 in the in-plane direction form a closed circuit. Due to this action, the thermal stability resistance increases because the magnetization of the perpendicular magnetic film 6 is established more strongly in the perpendicular direction.

In addition, in the case of a structure in which that the surface of the magnetizing stabilization film 13 is oxidized, the magnetic fluctuation of the surface of the magnetizing stabilization film 13 can be suppressed, and thereby the noise that originates in this magnetic fluctuation can be reduced, and the replay characteristics of the magnetic recording medium can be improved.

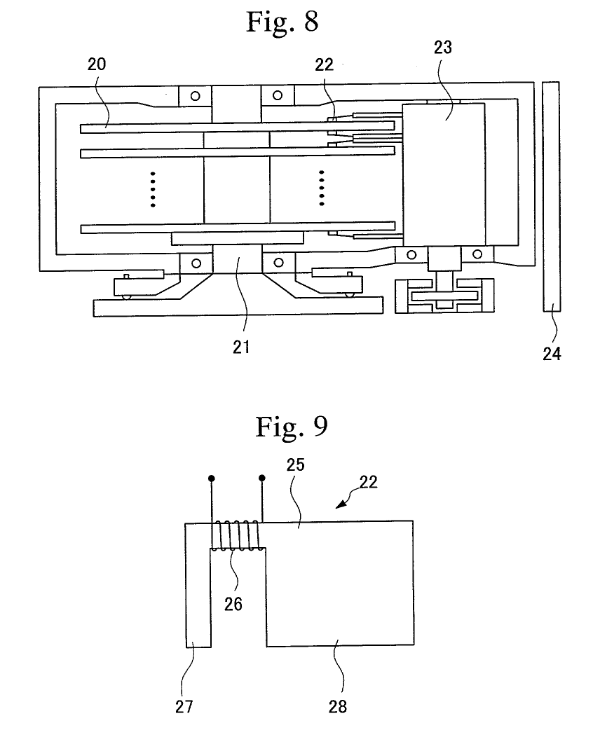

FIG. 8 is a cross-sectional structural drawing showing an example of the recording replay apparatus according to the present invention.

The magnetic replay apparatus shown in this figure comprises a magnetic recording medium 20 having the structure described above, a medium drive unit 21 that rotates this magnetic recording medium 20, a magnetic head 22 that carries out recording and replay of the information on the magnetic recording medium 20, a head drive unit 23 that drives the magnetic head 22, and a replay signal processing system 24.

The replay signal processing system 24 sends a recorded signal to the magnetic head 2 after processing the input data, and outputs the data after processing the replay signal from the magnetic head 22.

Preferably a single magnetic head is used as the magnetic head 22.

FIG. 9 is a drawing showing an example of a single magnetic head. The single magnetic head 22 has a simplified structure comprising a magnetic pole 25 and a coil 26. The magnetic pole 25 is approximately C-shaped when viewed from the side, and has a main magnetic pole 27 having a narrow width and an auxiliary magnetic pole 28 having a wide width. The main magnetic pole 27 generates a magnetic field that is applied to the perpendicular magnetic film 6 during recording, and can detect a magnetic flux from the perpendicular magnetic film 6 during replay.

When carrying out recording on the magnetic recording medium 20 using a single magnetic head 22, the magnetic flux issuing from the distal end of the main magnetic pole 27 magnetizes the perpendicular magnetic film 6 in the direction perpendicular to the substrate 1.

At this time, because the soft magnetic undercoat film 4 is provided in the magnetic recording medium 20, the magnetic flux from the main magnetic pole 27 of the single magnetic head 22 is guided to the auxiliary magnetic pole 28 by passing through the perpendicular magnetic film 6 and the soft magnetic undercoat film 4, and thereby a closed magnetic circuit is formed.

By this closed magnetic circuit being formed between the single magnetic head 22 and the magnetic recording medium 20, the efficiency of the flow of the magnetic flux increases, and high-density recording and replay become possible.

In addition, in the present invention, besides a single magnetic head, for example, a laminated thin film magnetic recording head providing a giant magnetoresistance (GMR) element can be used in the replay unit.

In the magnetic recording and replay apparatus of the present embodiment, the magnetic recording medium 20 is structured so as to provide the in-plane undercoat film 2 and the in-plane hard magnetic film 3 between the non-magnetic substrate 1 and the soft magnetic undercoat film 4, and thus noise that originates in the in-plane hard magnetic film 3 can be suppressed.

Thus, by making the soft magnetic undercoat film 4 thin, the production efficiency can be increased, and furthermore, superior noise characteristics can be obtained. Therefore, high-density recording and replay become possible.

### EXAMPLES

Below, the operational effect of the present invention will be clarified in examples.

### Example 1

A washed glass substrate 1 (Ohara Co.; circumference 2.5 inches) is accommodated in the film formation chamber of a DC magnetron sputtering apparatus (Aneruva Corp., C-3010), and after expelling air in the film formation chamber up to a near vacuum of 1×10⁻⁵ Pa, the seed film 9 (thickness, 50 nm) comprising 50Ni50Al, the in-plane undercoat film 2 (thickness, 15 nm) comprising 94Cr6Mo, the in-plane hard magnetic film 3 (thickness, 50 nm) comprising 61Co22Cr12Pt5B, and the soft magnetic undercoat film 4 (thickness, 150 nm) comprising 92Co4Ta4Zr, are formed on the glass substrate 1.

As a result of measuring using a vibration-type magnetic characteristics measuring apparatus (Vibrating Sample Magnetometer: VSM), the Bs of the soft magnetic undercoat film 4 was confirmed to be 1.3 T.

The static electricity characteristics of the soft magnetic undercoat film 4 were measured using a Kerr effect measuring apparatus, and the coercive force was 4570 (Oe) and the reverse magnetic domain nucleation field was 750 (Oe).

During the film formation described above argon is used as a process gas, and the gas pressure was set at 0.5 Pa. In addition the temperature condition during film formation was 200° C.

Next, the protective film 7, which comprises carbon, was formed using a CVD method. Next, the lubrication film 8, which comprises perfluoropolyether, is formed using a deep coating method, and the magnetic recording medium is obtained (refer to Table 1).

Moreover, in the above description of the alloy material, aAbB indicates a(at %)A-b(at %)B. For example, 61Co22Cr12Pt5B denotes 61 at % Co-22 at % Cr-12 ar % Pt-5at % B (a Co content of 61 at %, a Cr content of 22 at %, a Pt content of 12 at %, and a B content of 5 at %).

### Comparative Example 1

Except for using the material shown in Table 1 as the material for the in-plane hard magnetic film 3, the magnetic recording medium was fabricated according to example 1 (refer to Table 1).

### Comparative Example 2

Except for using the material shown in Table 1 as the material for the in-plane undercoat film 2, the magnetic recording medium was fabricated according to example 1 (refer to Table 1).

### Comparative Example 3

Except for not providing the seed film 9 and the in-plane undercoat film 2 and using SmCo in the in-plane hard magnetic film 3, the magnetic recording medium was fabricated according to example 1 (refer to Table 1).

### Comparative Example 4

Except for not providing the seed film 9, the in-plane undercoat film 2, and the in-plane hard magnetic film 3, the magnetic recording medium was fabricated according to example 1 (refer to Table 1).

### Example 1

Except for forming the orientation control undercoat film 11 (thickness 8 nm) comprising 50Ni50Al, the orientation control film 5 (thickness 10 nm) comprising Ru, and the perpendicular magnetic film 6 (thickness 25 nm) comprising 65Co17Cr16Pt2B, the magnetic recording medium was fabricated according to example 1 (refer to Table 2).

As a result of measurements using a transmission electron microscope (TEM), the average crystal particle diameter in the perpendicular magnetic film 6 was found to be 9 nm.

### Comparative Example 5

Except for using the material indicated in Table 2 for the material of the in-plane hard magnetic film 3, the magnetic recording medium was fabricated according to example 2 (refer to Table 2).

### Comparative Example 6

Except for using the material indicated in Table 2 for the material of the in-plane undercoat film 2, the magnetic recording medium was fabricated according to example 2 (refer to Table 2).

### Comparative Example 7

Except for not providing the seed film 9 and the in-plane undercoat film 2, and using SmCo in the in-plane hard magnetic film 3, the magnetic recording medium was fabricated according to example 2 (refer to Table 2).

### Comparative Example 8

Except for not providing the seed film 9, the in-plane undercoat film 2, and the in-plane hard magnetic film 3, the magnetic recording medium was fabricated according to example 2 (refer to Table 2).

### Examples 3 to 14

Except for using the materials shown in Table 3 for the material for the in-plane hard magnetic film 3, the magnetic recording medium was fabricated according to example 1 (refer to Table 3).

### Examples 15 and 16

Except for making the magnetic recovery factor of the soft magnetic undercoat film 4 as indicated in Table 4, the magnetic recording medium was fabricated according to example 1 (refer to Table 4).

### Examples 17 and 18

Except for making the coercive angle to squareness ratio S* of the in-plane hard magnetic film 3 as indicated in Table 5, the magnetic recording medium was fabricated according to example 1 (refer to Table 5).

### Examples 19 to 28

Except for making the materials and thickness of the materials for the soft magnetic undercoat film 4 as indicated in Table 6, the magnetic recording medium was fabricated according to example 2 (refer to Table 6).

### Examples 29 to 40

Except for making the materials and thickness of the orientation control undercoat film 11 and the orientation control film 5 as indicated in Table 7, the magnetic recording medium was fabricated according to example 2 (refer to Table 7).

### Examples 41 to 49

Except for making the materials and thickness of the perpendicular magnetic film 6 as indicated in Table 8, the magnetic recording medium was fabricated according to example 2 (refer to Table 8).

### Examples 50 to 53

Except for carrying out oxidizing treatment on the soft magnetic undercoat film 4 by exposing the surface of the soft magnetic undercoat film 4 to an oxygen containing gas (exposure gas), the magnetic recording medium was fabricated according to example 2. As an exposure gas, pure oxygen (100% O₂) or an oxygen-argon mixed gas (mixture ratio: 50 vol % O2 to 50 vol % Ar) was used.

The structure of this magnetic recording medium and the thickness of the oxide layer formed on the surface of the soft magnetic undercoat film 4 by the exposure described above is shown in Table 9.

### Example 54

Except for using Ar (100%) as the process gas (film formation gas) when forming the soft magnetic undercoat film 4, and then using an oxygen-argon mixed gas (mixture ratio: 10 vol % O₂ to 90 vol % Ar), the magnetic recording medium was fabricated according to example 2.

By using the oxygen-argon mixed gas, the oxide layer is formed in proximity to the surface of the soft magnetic undercoat film 4. The thickness of this oxide layer is shown in Table 9.

### Examples 55 to 62

Except for providing the non-magnetic middle film 12 and the materials and thickness of the non-magnetic middle film 12 indicated in Table 10, the magnetic recording medium was fabricated according to example 2 (refer to Table 10).

### Examples 63 to 67

Except for providing the magnetizing stabilization film 13 and the material and thickness of the magnetizing stabilization film 13 shown in Table 11, the magnetic recording medium was fabricated according to example 2 (refer to Table 11).

### Examples 68 to 70

Except for changing the coercive force of the in-plane hard magnetic film 3 by changing the temperature conditions when forming the in-plane hard magnetic film 3, the magnetic recording medium was fabricated according to example 1 (refer to Table 12).

The magnetic characteristics of each of the magnetic recording media was measured using a Vibrating Sample Magnetometer (VSM), the read-write analyzer RWA 1632 by GUZIK Co., and a spin-stand S1701 MP. The measurement results are shown in Tables 1 to 12.

The evaluation of the thermal stability resistance was made by calculating the decrease rate (%/decade) of the output of the replay output after writing at a track recording density of 50 KFCI after heating the substrate to 70° C. one second after writing based on (So—S)×100/(So×3). In this equation, So denotes the replay output when one second has passed after the signal recording onto the magnetic recording medium, and S denotes the replay output after 1000 seconds.

TABLE 1

| | | | COMPARATIVE | COMPARATIVE | COMPARATIVE | COMPARATIVE |
|---|---|---|---|---|---|---|
| | | EXAMPLE 1 | EXAMPLE 1 | EXAMPLE 2 | EXAMPLE 3 | EXAMPLE 4 |
| SEED FILM | COMPOSITION | NiAl | NiAl | NiAl | — | — |
| | THICKNESS | 50 | 50 | 50 | — | — |
| IN-PLANE | COMPOSITION | CrMo | CrMo | V | — | — |
| UNDERCOAT | THICKNESS | 15 | 15 | 15 | — | — |
| FILM | | | | | | |
| IN-PLANE | COMPOSITION | Co22Cr12Pt5B | Co20Pt | Co22Cr12Pt5B | SmCo | — |
| HARD | THICKNESS | 50 | 50 | 50 | 50 | — |
| MAGNETIC | | | | | | |
| FILM | | | | | | |
| SOFT | COMPOSITION | 92Co4Ta4Zr | 92Co4Ta4Zr | 92Co4Ta4Zr | 92Co4Ta4Zr | 92Co4Ta4Zr |
| MAGNETIC | THICKNESS | 150 | 150 | 150 | 150 | 150 |
| UNDERCOAT | | | | | | |
| FILM | | | | | | |

| | | | | | |
|---|---|---|---|---|---|
| MEDIUM NOISE | 0.0345 | 0.1224 | 0.0885 | 0.1826 | 0.0312 |
| (RMS mV) | | | | | |
| SPIKE NOISE | NONE | NONE | NONE | NONE | PRESENT |

(thickness unit: nm)

TABLE 2

| | | | COMPARATIVE | COMPARATIVE | COMPARATIVE | COMPARATIVE |
|---|---|---|---|---|---|---|
| | | EXAMPLE 2 | EXAMPLE 5 | EXAMPLE 6 | EXAMPLE 7 | EXAMPLE 8 |
| SEED FILM | COMPOSITION | NiAl | NiAl | NiAl | — | — |
| | THICKNESS | 50 | 50 | 50 | — | — |
| IN-PLANE | COMPOSITION | CrMo | CrMo | V | — | — |
| UNDERCOAT | THICKNESS | 15 | 15 | 15 | — | — |
| FILM | | | | | | |
| IN-PLANE HARD | COMPOSITION | Co22Cr12Pt5B | Co20Pt | Co22Cr12Pt5B | SmCo | — |
| MAGNETIC FILM | THICKNESS | 50 | 50 | 50 | 50 | — |
| SOFT MAGNETIC | COMPOSITION | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 |
| ORIENTATION | COMPOSITION | NiA1 | NiA1 | NiA1 | NiA1 | NiA1 |
| CONTROL | THICKNESS | 8 | 8 | 8 | 8 | 8 |
| UNDERCOAT FILM | | | | | | |
| ORIENTATION | COMPOSITION | Ru | Ru | Ru | Ru | Ru |
| CONTROL FILM | THICKNESS | 10 | 10 | 10 | 10 | 10 |
| PERPENDICULAR | COMPOSITION | 65Co17Cr16Pt2B | 65Co17Cr16Pt2B | 65Co17Cr16Pt2B | 65Co17Cr16Pt2B | 65Co17Ct16Pr2B |
| MAGNETIC FILM | THICKNESS | 25 | 25 | 25 | 25 | 25 |

| | | | | | |
|---|---|---|---|---|---|
| RECORD/WRITE PROPERTIES | −6.3 | −3.5 | −4.1 | −3.2 | −2.1 |
| ERROR RATE(10^{X}) | | | | | |
| SPIKE NOISE | NONE | NONE | NONE | NONE | PRESENT |

(thickness unit: nm)

TABLE 3

| | | EXAMPLE 3 | EXAMPLE 4 | EXAMPLE 5 | EXAMPLE 6 | EXAMPLE 7 | EXAMPLE 8 |
|---|---|---|---|---|---|---|---|
| SEED FILM | COMPOSITION | NiAl | NiAl | NiAl | NiAl | NiAl | NiAl |
| | THICKNESS | 50 | 50 | 50 | 50 | 50 | 50 |
| IN-PLANE | COMPOSITION | CrMo | CrMo | CrMo | CrMo | CrMo | CrMo |
| UNDERCOAT FILM | THICKNESS | 15 | 15 | 15 | 15 | 15 | 15 |
| IN-PLANE HARD | COMPOSITION | Co22Cr12Pt5B | Co18Cr8Pt5Ta | Co21Cr10Pt3Ta | Co20Cr8Pt3B3Cu | Co22Cr12Pt5B | Co22Cr12pt5B |
| MAGNETIC FILM | THICKNESS | 50 | 50 | 50 | 50 | 5 | 15 |
| | Ms (emu/cm³) | 320 | 385 | 340 | 320 | 300 | 310 |
| SOFT MAGNETIC | COMPOSITION | 92Co4Ta4Zr | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 | 150 |

| | | | | | | |
|---|---|---|---|---|---|---|
| MEDIUM NOISE (RMS mV) | 0.0345 | 0.0424 | 0.0436 | 0.0382 | 0.0331 | 0.0335 |
| SPIKE NOISE | NONE | NONE | NONE | NONE | SLIGHT | NONE |

| | | EXAMPLE 9 | EXAMPLE 10 | EXAMPLE 11 | EXAMPLE 12 | EXAMPLE 13 | EXAMPLE 14 |
|---|---|---|---|---|---|---|---|
| SEED FILM | COMPOSITION | NiAl | NiAl | NiAl | NiAl | NiAl | NiAl |
| | THICKNESS | 50 | 50 | 50 | 50 | 50 | 50 |
| IN-PLANE | COMPOSITION | CrMo | CrMo | CrMo | CrMo | CrMo | CrMo |
| UNDERCOAT FILM | THICKNESS | 15 | 15 | 15 | 15 | 15 | 15 |
| IN-PLANE HARD | COMPOSITION | Co22Cr12Pt5B | Co22Cr12Pt5B | Co14Cr8Pt2Ta | Co10Cr10Pt2Ta | Co25Cr12Pt4B | Co24Cr13Pt4B |
| MAGNETIC FILM | THICKNESS | 95 | 120 | 50 | 50 | 50 | 50 |
| | Ms (emu/cm³) | 330 | 350 | 550 | 750 | 190 | 220 |
| SOFT MAGNETIC | COMPOSITION | 92Co4Ta4Zr | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 | 150 |

| | | | | | | |
|---|---|---|---|---|---|---|
| MEDIUM NOISE (RMS mV) | 0.0499 | 0.0801 | 0.0512 | 0.0955 | 0.0335 | 0.0329 |
| SPIKE NOISE | NONE | NONE | NONE | NONE | SLIGHT | NONE |

(thickness unit: nm)

TABLE 4

| | | EXAMPLE 1 | EXAMPLE 15 | EXAMPLE 16 |
|---|---|---|---|---|
| SEED FILM | COMPOSITION | NiAl | NiAl | NiAl |
| | THICKNESS | 50 | 50 | 50 |
| IN-PLANE | COMPOSITION | CrMo | CrMo | CrMo |
| UNDERCOAT | THICKNESS | 15 | 15 | 15 |
| FILM | | | | |
| IN-PLANE HARD | COMPOSITION | Co22Cr12Pt5B | Co22Cr12Pt5B | Co22Cr12Pt5B |
| MAGNETIC FILM | THICKNESS | 50 | 50 | 50 |
| SOFT MAGNETIC | COMPOSITION | 92Co4Ta4Zr | 92Co4Ta4Zr | 92Co4Ta4Zr |
| UNDERCOAT FILM | THICKNESS | 150 | 150 | 150 |

| | | | |
|---|---|---|---|
| MEDIUM NOISE (RMS mV) | 0.0345 | 0.338 | 0.0339 |
| MAGNETIZATION RECOVERY | 0.95 | 0.87 | 0.80 |
| FACTOR (%) | | | |
| SPIKE NOISE | NONE | NONE | SLIGHT |

Magnetic recovery factor: the magnetization recovery rate of the soft magnetization undercoat film (Thickness unit: nm)

TABLE 5

| | | EXAMPLE 1 | EXAMPLE 17 | EXAMPLE 18 |
|---|---|---|---|---|
| SEED FILM | COMPOSITION | NiAl | NiAl | NiAl |
| | THICKNESS | 50 | 50 | 50 |
| IN-PLANE | COMPOSITION | CrMo | CrMo | CrMo |
| UNDERCOAT | THICKNESS | 15 | 15 | 15 |
| FILM | | | | |
| IN-PLANE HARD | COMPOSITION | Co22Cr12Pt5B | Co22Cr12Pt5B | Co22Cr12Pt5B |
| MAGNETIC FILM | THICKNESS | 50 | 50 | 50 |
| SOFT MAGNETIC | COMPOSITION | 92Co4Ta4Zr | 92Co4Ta4Zr | 92Co4Ta4Zr |
| UNDERCOAT FILM | THICKNESS | 150 | 150 | 150 |

| | | | |
|---|---|---|---|
| MEDIUM NOISE (RMS mV) | 0.0345 | 0.338 | 0.0331 |
| COERCIVE FORCE TO | | | |
| SQUARENESS RATIO S*(-) | 0.73 | 0.63 | 0.55 |
| SPIKE NOISE | NONE | NONE | SLIGHT |

Coercive force to squareness ratio S*: the coercive force to squareness ratio S* of the in-plane hard magnetic film (Thickness unit: nm)

TABLE 6

| | | EXAMPLE 2 | EXAMPLE 19 | EXAMPLE 20 | EXAMPLE 21 | EXAMPLE 22 | EXAMPLE 23 |
|---|---|---|---|---|---|---|---|
| SEED FILM | COMPOSITION | NiAl | NiAl | NiAl | NiAl | NiAl | NiAl |
| | THICKNESS | 50 | 50 | 50 | 50 | 50 | 50 |
| IN-PLANE | COMPOSITION | CrMo | CrMo | CrMo | CrMo | CrMo | CrMo |
| UNDERCOAT FILM | THICKNESS | 15 | 15 | 15 | 15 | 15 | 15 |
| IN-PLANE HARD | COMPOSITION | Co22Cr12Pt5B | Co22Cr12Pt5B | Co22Cr12Pt5B | Co22Cr12Pt5B | Co22Cr12Pt5B | Co22Cr12Pt5B |
| MAGNETIC FILM | THICKNESS | 50 | 50 | 50 | 50 | 50 | 50 |
| SOFT MAGNETIC | COMPOSITION | 92Co4Ta4Zr | 88Co4Ta8Zr | 85Co7Ta8Zr | 80Fe10Ta10C | 82Fe6Zr12N | 78Fe22(SiO2) |
| UNDERCOAT FILM | THICKNESS | 150 | 150 | 150 | 150 | 150 | 150 |
| | Bs (T) | 1.3 | 1.0 | 0.8 | 1.6 | 1.7 | 1.4 |
| ORIENTATION CONTROL | COMPOSITION | NiAl | NiAl | NiAl | NiAl | NiAl | NiAl |
| UNDERCOAT FILM | THICKNESS | 8 | 8 | 8 | 8 | 8 | 8 |
| ORIENTATION | COMPOSITION | Ru | Ru | Ru | Ru | Ru | Ru |
| CONTROL FILM | THICKNESS | 10 | 10 | 10 | 10 | 10 | 10 |

| | | | | | | |
|---|---|---|---|---|---|---|
| PERPENDICULAR MAGNETIC FILM | *1 | *1 | *1 | *1 | *1 | *1 |
| RECORD/WRITE PROPERTIES | −6.3 | −6.1 | −5.1 | −6.1 | −6.3 | −6.2 |
| ERROR RATE(10^{X}) | | | | | | |
| SPIKE NOISE | NONE | NONE | NONE | NONE | NONE | NONE |

| | | EXAMPLE 24 | EXAMPLE 25 | EXAMPLE 26 | EXAMPLE 27 | EXAMPLE 28 |
|---|---|---|---|---|---|---|
| SEED FILM | COMPOSITION | NiAl | NiAl | NiAl | NiAl | NiAl |
| | THICKNESS | 50 | 50 | 50 | 50 | 50 |
| IN-PLANE | COMPOSITION | CrMo | CrMo | CrMo | CrMo | CrMo |
| UNDERCOAT FILM | THICKNESS | 15 | 15 | 15 | 15 | 15 |
| IN-PLANE HARD | COMPOSITION | Co22Cr12Pt5B | Co22Cr12Pt5B | Co22Cr12Pt5B | Co22Cr12Pt5B | Co22Cr12Pt5B |
| MAGNETIC FILM | THICKNESS | 50 | 50 | 50 | 50 | 50 |
| SOFT MAGNETIC | COMPOSITION | 92Co4Ta4Zr | 92Co4Ta4Zr | 92Co4Ta4Zr | 92Co4Ta4Zr | 92Co4Ta4Zr |
| UNDERCOAT FILM | THICKNESS | 40 | 60 | 105 | 210 | 400 |
| | Bs (T) | 1.3 | 1.3 | 1.3 | 1.3 | 1.3 |
| ORIENTATION CONTROL | COMPOSITION | NiAl | NiAl | NiAl | NiAl | NiAl |
| UNDERCOAT FILM | THICKNESS | 8 | 8 | 8 | 8 | 8 |
| ORIENTATION | COMPOSITION | Ru | Ru | Ru | Ru | Ru |
| CONTROL FILM | THICKNESS | 10 | 10 | 10 | 10 | 10 |

| | | | | | |
|---|---|---|---|---|---|
| PERPENDICULAR MAGNETIC FILM | *1 | *1 | *1 | *1 | *1 |
| RECORD/WRITE PROPERTIES | −4.6 | −5.8 | −6.3 | −6.3 | −6.1 |
| ERROR RATE(10^{X}) | | | | | |
| SPIKE NOISE | NONE | NONE | NONE | NONE | NONE |

*1: perpendicular magnetic film: 65 Co17Cr16Pt2B; thickness, 25 nm (Thickness unit: nm)

TABLE 7

| | | EXAMPLE 2 | EXAMPLE 29 | EXAMPLE 30 | EXAMPLE 31 | EXAMPLE 32 |
|---|---|---|---|---|---|---|
| SEED FILM | COMPOSITION | NiAl | NiAl | NiAl | NiAl | NiAl |
| | THICKNESS | 50 | 50 | 50 | 50 | 50 |
| IN-PLANE | COMPOSITION | CrMo | CrMo | CrMo | CrMo | CrMo |
| UNDERCOAT FILM | THICKNESS | 15 | 15 | 15 | 15 | 15 |
| IN-PLANE HARD | COMPOSITION | Co22Cr12Pt5B | Co22Cr12Pt5B | Co22Cr12Pt5B | Co22Cr12Pt5B | Co22Cr12Pt5B |
| MAGNETIC FILM | THICKNESS | 50 | 50 | 50 | 50 | 50 |
| SOFT MAGNETIC | COMPOSITION | 92Co4Ta4Zr | 88Co4Ta8Zr | 85Co7Ta8Zr | 88Co4Ta8Zr | 85Co7Ta8Zr |
| UNDERCOAT FILM | THICKNESS | 150 | 150 | 150 | 150 | 150 |
| | Bs (T) | 1.3 | 1.3 | 1.3 | 1.3 | 1.3 |
| ORIENTATION CONTROL | COMPOSITION | 50Ni50Al | — | — | — | — |
| UNDERCOAT FILM | THICKNESS | 8 | — | — | — | — |
| ORIENTATION | COMPOSTION | Ru | Ru | Ru | Ru | 70Ru30Cr |
| CONTROL FILM | THICKNESS | 10 | 2 | 18 | 45 | 18 |

| | | | | | |
|---|---|---|---|---|---|
| PERPENDICULAR MAGNETIC FILM | *1 | *1 | *1 | *1 | *1 |
| RECORD/WRITE PROPERTIES | −6.3 | −6.1 | −6.2 | −5.9 | −6.6 |
| ERROR RATE(10^{X}) | | | | | |

| | | EXAMPLE 33 | EXAMPLE 34 | EXAMPLE 35 | EXAMPLE 36 |
|---|---|---|---|---|---|
| SEED FILM | COMPOSITION | NiAl | NiAl | NiAl | NiAl |
| | THICKNESS | 50 | 50 | 50 | 50 |
| IN-PLANE | COMPOSITION | CrMo | CrMo | CrMo | CrMo |
| UNDERCOAT FILM | THICKNESS | 15 | 15 | 15 | 15 |
| IN-PLANE HARD | COMPOSITION | Co22Cr12Pt5B | Co22Cr12Pt5B | Co22Cr12Pt5B | Co22Cr12Pt5B |
| MAGNETIC FILM | THICKNESS | 50 | 50 | 50 | 50 |
| SOFT MAGNETIC | COMPOSITION | 80Fe10Ta10C | 80Fe10Ta10C | 82Fe6Zr12N | 78Fe22(SiO2) |
| UNDERCOAT FILM | THICKNESS | 150 | 150 | 150 | 150 |
| | Bs (T) | 1.3 | 1.3 | 1.3 | 1.3 |
| ORIENTATION CONTROL | COMPOSITION | — | — | 50Ni50Al | — |
| UNDERCOAT FILM | THICKNESS | — | — | 8 | — |
| ORIENTATION | COMPOSTION | Hf | 80Fh20B | Re | Ni |
| CONTROL FILM | THICKNESS | 18 | 18 | 8 | 3 |
| PERPENDICULAR MAGNETIC FILM | | *1 | *1 | *1 | *1 |
| RECORD/WRITE PROPERTIES | | −6.7 | −6.8 | −5.8 | −6.1 |
| ERROR RATE(10^{X}) | | | | | |
| | | EXAMPLE 37 | EXAMPLE 38 | EXAMPLE 39 | EXAMPLE 40 |
| SEED FILM | COMPOSITION | NiAl | NiAl | NiAl | NiAl |
| | THICKNESS | 50 | 50 | 50 | 50 |
| IN-PLANE | COMPOSITION | CrMo | CrMo | CrMo | CrMo |
| UNDERCOAT FILM | THICKNESS | 15 | 15 | 15 | 15 |
| IN-PLANE HARD | COMPOSITION | Co22Cr12Pt5B | Co22Cr12Pt5B | Co22Cr12Pt5B | Co22Cr12Pt5B |
| MAGNETIC FILM | THICKNESS | 50 | 50 | 50 | 50 |
| SOFT MAGNETIC | COMPOSITION | 92Co4Ta4Zr | 92Co4Ta4Zr | 92Co4Ta4Zr | 92Co4Ta4Zr |
| UNDERCOAT FILM | THICKNESS | 150 | 150 | 150 | 150 |
| | Bs (T) | 1.3 | 1.3 | 1.3 | 1.3 |
| ORIENTATION CONTROL | COMPOSITION | 50Ni50Al | — | — | — |
| UNDERCOAT FILM | THICKNESS | 8 | — | — | — |
| ORIENTATION | COMPOSTION | Ni | 85Ni10Cr5N | Cu | 80Pd20B |
| CONTROL FILM | THICKNESS | 3 | 10 | 15 | 10 |

| | | | | |
|---|---|---|---|---|
| PERPENDICULAR MAGNETIC FILM | *1 | *1 | *1 | *1 |
| RECORD/WRITE PROPERTIES | −6.1 | −6.3 | −5.8 | −5.9 |
| ERROR RATE(10^{X}) | | | | |

*1: perpendicular magnetic film: 65Co17Cr16Pt2B; thickness, 25 nm (Thickness unit: nm)

TABLE 8

| | | EXAMPLE 2 | EXAMPLE 41 | EXAMPLE 42 | EXAMPLE 43 | EXAMPLE 44 |
|---|---|---|---|---|---|---|
| SEED FILM | COMPOSITION | NiAl | NiAl | NiAl | NiAl | NiAl |
| | THICKNESS | 50 | 50 | 50 | 50 | 50 |
| IN-PLANE | COMPOSITION | CrMo | CrMo | CrMo | CrMo | CrMo |
| UNDERCOAT FILM | THICKNESS | 15 | 15 | 15 | 15 | 15 |
| IN-PLANE HARD | COMPOSITION | Co22Cr12Pt5B | Co22Cr12Pt5B | Co22Cr12Pt5B | Co22Cr12Pt5B | Co22Cr12Pt5B |
| MAGNETIC FILM | THICKNESS | 50 | 50 | 50 | 50 | 50 |
| SOFT MAGNETIC | COMPOSITION | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 |
| ORIENTATION CONTROL | COMPOSITION | NiAl | NiAl | NiAl | NiAl | NiAl |
| UNDERCOAT FILM | THICKNESS | 8 | 8 | 8 | 8 | 8 |
| ORIENTATION | COMPOSITION | Ru | Ru | Ru | Ru | Ru |
| CONTROL FILM | THICKNESS | 10 | 10 | 10 | 10 | 10 |
| PERPENDICULAR | COMPOSITION | 65Co17Cr16Pt2B | 65Co17Cr16Pt2B | 65Co17Cr16Pt2B | 65Co17Cr16Pt2B | 65Co17Cr16Pt2B |
| MAGNETIC FILM | THICKNESS | 25 | 3 | 8 | 45 | 60 |
| RECORD/WRITE PROPERTIES | | −6.3 | −4.9 | −6.0 | −5.8 | −5.1 |
| ERROR RATE(10^{X}) | | | | | | |
| THERMAL DECAY(%/decade) | | 0.65 | 1.03 | 0.88 | 0.55 | 0.52 |
| | | EXAMPLE 45 | EXAMPLE 46 | EXAMPLE 47 | EXAMPLE 48 | EXAMPLE 49 |
| SEED FILM | COMPOSITION | NiAl | NiAl | NiAl | NiAl | NiAl |
| | THICKNESS | 50 | 50 | 50 | 50 | 50 |
| IN-PLANE | COMPOSITION | CrMo | CrMo | CrMo | CrMo | CrMo |
| UNDERCOAT FILM | THICKNESS | 15 | 15 | 15 | 15 | 15 |
| IN-PLANE HARD | COMPOSITION | Co22Cr12Pt5B | Co22Cr12Pt5B | Co22Cr12Pt5B | Co22Cr12Pt5B | Co22Cr12Pt5B |
| MAGNETIC FILM | THICKNESS | 50 | 50 | 50 | 50 | 50 |
| SOFT MAGNETIC | COMPOSITION | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 |
| ORIENTATION CONTROL | COMPOSITION | NiAl | NiAl | NiAl | NiAl | NiAl |
| UNDERCOAT FILM | THICKNESS | 8 | 8 | 8 | 8 | 8 |
| ORIENTATION | COMPOSITION | Ru | Ru | Ru | Ru | Ru |
| CONTROL FILM | THICKNESS | 10 | 10 | 10 | 10 | 10 |
| PERPENDICULAR | COMPOSITION | 65Co17Cr16Pt2B | 68Co21Cr6Pt5B | 61Co17Cr21 | Co/Pd (1* | TbFeCo |
| MAGNETIC FILM | THICKNESS | 25 | 25 | 25 | 15 | 25 |

| | | | | | |
|---|---|---|---|---|---|
| RECORD/WRITE PROPERTIES | −6.1 | −6.3 | −5.6 | −5.3 | −5.1 |
| ERROR RATE(10^{X}) | | | | | |
| THERMAL DECAY(%/decade) | 0.71 | 1.08 | 0.49 | 0.36 | 0.64 |

*1: perpendicular magnetic film: 65Co17Cr16Pt2B; thickness, 25 nm (Thickness unit: nm)

TABLE 9

| | | EXAMPLE 2 | EXAMPLE 50 | EXAMPLE 51 | EXAMPLE 52 | EXAMPLE 53 | EXAMPLE 54 |
|---|---|---|---|---|---|---|---|
| SEED FILM | | *1 | *1 | *1 | *1 | *1 | *1 |
| IN-PLANE UNDERCOAT FILM | | *2 | *2 | *2 | *2 | *2 | *2 |
| IN-PLANE HARD MAGNETIC FILM | | *3 | *3 | *3 | *3 | *3 | *3 |
| SOFT MAGNETIC | COMPOSITION | 92Co4Ta4Zr | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 | 150 |
| | Bs(T) | 1.3 | 1.3 | 1.3 | 1.3 | 1.3 | 1.3 |
| | EXPOSURE GAS | — | 100% O₂ | 100% O₂ | 100% O₂ | 50% O₂-50% Ar | 50% O₂-50% Ar |
| | (PROCESS GAS) | | | | | | |
| | TREATMENT | — | Exposure | Exposure | Exposure | Exposure | *5 |
| | PROCESS | | | | | | |
| | OXIDE LAYER | — | 0.5 | 2.5 | 4 | 1 | 1 |
| | THICKNESS | | | | | | |
| ORIENTATION | COMPOSITION | NiAl | NiAl | NiAl | NiAl | NiAl | NiAl |
| CONTROL | THICKNESS | 8 | 8 | 8 | 8 | 8 | 8 |
| UNDERCOAT FILM | | | | | | | |
| ORIENTATION | COMPOSITION | Ru | Ru | Ru | Ru | Ru | Ru |
| CONTROL FILM | THICKNESS | 10 | 10 | 10 | 10 | 10 | 10 |

| | | | | | | |
|---|---|---|---|---|---|---|
| PERPENDICULAR MAGNETIC FILM | *4 | *4 | *4 | *4 | *4 | *4 |
| RECORD/WRITE PROPERTIES | −6.3 | −7.1 | −6.9 | −6.1 | −6.8 | −6.7 |
| ERROR RATE(10^{X}) | | | | | | |

*1 seed film: 50Ni50Al; thickness, 50 nm
*2 in-plane undercoat film: 94Cr6Mo; thickness, 15 nm
*3 in-plane hard magnetic film: 61Co22Cr12Pt5B; thickness, 50 nm
*4 perpendicular magnetic film: 65Co17Cr16Pt2B; thickness, 25 nm
*5 after using 100% Ar as a process gas during the soft magnetic undercoat film formation, 10% O2 to 90% Ar is used (thickness unit: nm)

TABLE 10

| | | EXAMPLE 2 | EXAMPLE 55 | EXAMPLE 56 | EXAMPLE 57 | EXAMPLE 58 |
|---|---|---|---|---|---|---|
| SEED FILM | | *1 | *1 | *1 | *1 | *1 |
| IN-PLANE UNDERCOAT FILM | | *2 | *2 | *2 | *2 | *2 |
| IN-PLANE HARD MAGNETIC FILM | | *3 | *3 | *3 | *3 | *3 |
| SOFT MAGNETIC | COMPOSITION | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 |
| | Bs(T) | 1.3 | 1.3 | 1.3 | 1.3 | 1.3 |
| ORIENTATION CONTROL | COMPOSITION | NiAl | NiAl | NiAl | NiAl | NiAl |
| UNDERCOAT FILM | THICKNESS | 8 | 8 | 8 | 8 | 8 |
| ORIENTATION | COMPOSITION | Ru | Ru | Ru | Ru | Ru |
| CONTROL FILM | THICKNESS | 10 | 10 | 10 | 10 | 10 |
| NON-MAGNETIC | COMPOSITION | — | 60Co40Cr | 60Co40Cr | 60Co40Cr | 60Co40Cr |
| MIDDLE FILM | THICKNESS | — | 5 | 2 | 18 | 25 |

| | | | | | |
|---|---|---|---|---|---|
| PERPENDICULAR MAGNETIC FILM | *4 | *4 | *4 | *4 | *4 |
| RECORD/WRITE PROPERTIES | −6.3 | −7.1 | −6.9 | −6.1 | −6.8 |
| ERROR RATE(10^{X}) | | | | | |
| THERMAL DECAY(%/decade) | 0.65 | 0.55 | 0.57 | 0.57 | 0.52 |

| | | EXAMPLE 59 | EXAMPLE 60 | EXAMPLE 61 | EXAMPLE 62 |
|---|---|---|---|---|---|
| SEED FILM | | *1 | *1 | *1 | *1 |
| IN-PLANE UNDERCOAT FILM | | *2 | *2 | *2 | *2 |
| IN-PLANE HARD MAGNETIC FILM | | *3 | *3 | *3 | *3 |
| SOFT MAGNETIC | COMPOSITION | 92Co4Ta4Zr | 92Co4Ta4Zr | 92Co4Ta4Zr | 92Co4Ta4Zr |
| UNDERCOAT FILM | THICKNESS | 150 | 150 | 150 | 150 |
| | Bs(T) | 1.3 | 1.3 | 1.3 | 1.3 |
| ORIENTATION CONTROL | COMPOSITION | NiAl | NiAl | NiAl | NiAl |
| UNDERCOAT FILM | THICKNESS | 8 | 8 | 8 | 8 |
| ORIENTATION | COMPOSITION | Ru | Ru | Ru | Ru |
| CONTROL FILM | THICKNESS | 10 | 10 | 10 | 10 |
| NON-MAGNETIC | COMPOSITION | 55Co35Cr10Mn | 52Co33Cr10Pt5B | 55Co45Ru | 60Co30Cr5Ta5B |
| MIDDLE FILM | THICKNESS | 5 | 5 | 5 | 5 |

| | | | | |
|---|---|---|---|---|
| PERPENDICULAR MAGNETIC FILM | *4 | *4 | *4 | *4 |
| RECORD/WRITE PROPERTIES | −6.7 | −6.1 | −6.8 | −6.7 |
| ERROR RATE(10^{X}) | | | | |
| THERMAL DECAY(%/decade) | 0.56 | 0.55 | 0.58 | 0.54 |

*1 seed film: 50Ni50Al; thickness, 50 nm
*2 in-plane undercoat film: 94Cr6Mo; thickness, 15 nm
*3 in-plane hard magnetic film: 61Co22Cr12Pt5B; thickness, 50 nm
*4 perpendicular magnetic film: 65Co17Cr16Pt2B; thickness, 25 (thickness unit: nm)

TABLE 11

| | | EXAMPLE 2 | EXAMPLE 63 | EXAMPLE 64 | EXAMPLE 65 | EXAMPLE 66 | EXAMPLE 67 |
|---|---|---|---|---|---|---|---|
| SEED FILM | | *1 | *1 | *1 | *1 | *1 | *1 |
| IN-PLANE UNDERCOAT FILM | | *2 | *2 | *2 | *2 | *2 | *2 |
| IN-PLANE HARD MAGNETIC FILM | | *3 | *3 | *3 | *3 | *3 | *3 |
| SOFT MAGNETIC | COMPOSITION | 92Co4Ta4Zr | 92Co4Ta4Zr | 92Co4Ta4Zr | 92Co4Ta4Zr | 92Co4Ta4Zr | 92Co4Ta4Zr |
| UNDERCOAT FILM | THICKNESS | 150 | 150 | 150 | 150 | 150 | 150 |
| | Bs(T) | 1.3 | 1.3 | 1.3 | 1.3 | 1.3 | 1.3 |
| ORIENTATION | COMPOSITION | NiAl | NiAl | NiAl | NiAl | NiAl | NiAl |
| CONTROL | THICKNESS | 8 | 8 | 8 | 8 | 8 | 8 |
| UNDERCOAT FILM | | | | | | | |
| ORIENTATION | COMPOSITION | Ru | Ru | Ru | Ru | Ru | Ru |
| CONTROL FILM | THICKNESS | 10 | 10 | 10 | 10 | 10 | 10 |
| PERPENDICULAR MAGNETIC FILM | | *4 | *4 | *4 | *4 | *4 | *4 |
| MAGNETIZATION | COMPOSITION | — | 92Co4Ta4Zr | 92Co4Ta4Zr | 92Co4Ta4Zr | 85Fe15Zr | 89Co4Zr7Nb |
| STABILIZING FILM | THICKNESS | — | 3.6 | 7.0 | 9.6 | 3.6 | 3.6 |
| RECORD/WRITE | ERROR RATE | −6.3 | −6.7 | −6.2 | −5.7 | −6.4 | −6.5 |
| PROPERTIES | (l0^{X}) | | | | | | |
| | READBACK | 2180 | 2870 | 2350 | 1780 | 2660 | 2720 |
| | SIGNAL | | | | | | |

| | | | | | | |
|---|---|---|---|---|---|---|
| THERMAL DECAY(%/decade) | 0.65 | 0.45 | 0.53 | 0.74 | 0.52 | 0.51 |

*1 seed film: 50Ni50Al; thickness, 50 nm
*2 in-plane undercoat film: 94Cr6Mo; thickness, 15 nm
*3 in-plane hard magnetic film: 61Co22Cr12PtB5; thickness, 50 nm
*4 perpendicular magnetic film: 65Co17Cr16Pt2B; thickness, 25 nm (thickness unit: nm

TABLE 12

| | | EXAMPLE 1 | EXAMPLE 68 | EXAMPLE 69 | EXAMPLE 70 |
|---|---|---|---|---|---|
| SEED FILM | COMPOSITION | NiAl | NiAl | NiAl | NiAl |
| | THICKNESS | 50 | 50 | 50 | 50 |
| IN-PLANE | COMPOSITION | CrMo | CrMo | CrMo | CrMo |
| UNDERCOAT | THICKNESS | 15 | 15 | 15 | 15 |
| FILM | | | | | |
| IN-PLANE HARD | COMPOSITION | Co22Cr12Pt5B | Co22Cr12Pt5B | Co22Cr12Pt5B | Co22Cr12Pt5B |
| MAGNETIC FILM | THICKNESS | 50 | 50 | 50 | 50 |
| | COERCIVE | 3050 | 920 | 1150 | 2100 |
| | FORCE (Oe) | | | | |
| SOFT MAGNETIC | COMPOSITION | 92Co4Ta4Zr | 92Co4Ta4Zr | 92Co4Ta4Zr | 92Co4Ta4Zr |
| UNDERCOAT FILM | THICKNESS | 150 | 150 | 150 | 150 |

| | | | | |
|---|---|---|---|---|
| MEDIUM NOISE (RMS mV) | 0.0345 | 0.0451 | 0.30385 | 0.0355 |
| SPIKE NOISE | NONE | SLIGHT | NONE | NONE |

(Thickness unit: nm)

From Table 1 and Table 2, it can be understood that in comparison to the comparative examples that use CoPt and SmCo in the hard magnetic film, the example in which the in-plane hard magnetic film 3 comprising the CoCrPtB is provided between the non-magnetic substrate 1 and the soft magnetic undercoat film 4 obtained superior noise characteristics.

In the example using the Cr alloy in the in-plane undercoat film 2, it can be understood that in comparison to the comparative example that used V in the undercoat film, superior noise characteristics can be obtained.

From Table 3 it can be understood that by maintaining the saturated magnetism Ms of the in-plane hard magnetic film 3 in a range equal to or greater than 200 (memu/cm³) and below 600 (memu/cm³), and maintaining the thickness of the in-plane hard magnetic film 3 in a range equal to or greater than 10 nm and less than 100 nm, it was possible to obtain a noise reduction.

From Table 4 is can be understood that by making the magnetic restoring factor of the soft magnetic undercoat film 4 equal to or above 0.85, it was possible to obtain a noise reduction.

From Table 5 it can be understood that by making the coercive force to squareness ratio S* equal to or greater than 0.6, it was possible to obtain a noise reduction.

From Table 6 it can be understood that by making the saturated magnetic flux density Bs of the soft magnetic undercoat film 4 equal to or greater than 1 T (in particular, equal to or greater than 1.4 T), the read/write properties could be improved.

By forming the soft magnetizing undercoat film 4 so as to be thick and maintaining the Bs·t equal to or greater than 50 T·nm, particularly superior read/write properties can be obtained.

From Table 7 it can be understood that in the case of using a material shown in Table 7 for the orientation control film 5, superior read/write properties can be obtained.

From Table 8 it can be understood that in the case of using the materials shown in FIG. 8 for the perpendicular magnetic film 6, superior read/write properties can be obtained.

From Table 9 it can be understood that by oxidizing the soft magnetic undercoat film 4, superior read/write properties can be obtained.

From Table 10 it can be understood that by providing the non-magnetic middle film 12, superior results for the read/write properties and the thermal stability characteristics can be obtained.

From Table 11 it can be understood that by providing the magnetization stabilizing film 13, superior results for the read/write properties and the thermal stability characteristics can be obtained.

From Table 12 it can be understood that by maintaining the coercive force of the in-plane hard magnetic film 3 equal to or greater than 1000 (Oe), a magnetic recording medium having superior read/write properties can be obtained. In addition, by maintaining the coercive force equal to or greater than 2000 (Oe), results that are even more superior can be obtained.

According to the explanation described above, in the magnetic recording medium of the present invention, an in-plane undercoat layer and an in-plane hard magnetic film whose axis of easy magnetization is generally oriented in the in-plane direction are provided between the non-magnetic substrate and the soft magnetizing undercoat film, the in-plane undercoat film comprises Cr or a Cr alloy, and the in-plane hard magnetic film incorporates a CoCrPtX alloy (where X is one or more of B, Ta, Cu, Zr, Nb, Re, Ni, Mn, Ge, Si, O, or N). Thereby, the noise that originates in the in-plane hard magnetic film can be suppressed.

Thus, even in the case that the soft magnetizing undercoat film is formed so as to be thin, the increase in noise can be suppressed.

Therefore, the production efficiency can be increased by making the film of the soft magnetizing undercoat film thinner, and furthermore, superior noise characteristics can be obtained.

What is claimed is:

1. A magnetic recording medium formed on a non-magnetic substrate comprising:
at least a soft magnetic undercoat film comprising a soft magnetizing material;
an orientation control film for controlling the orientation of the film directly above;
a perpendicular magnetic film whose axis of easy magnetization is generally oriented perpendicular to the substrate;
a protective film; and
an in-plane undercoat film formed between the non-magnetic substrate and the soft magnetic undercoat film and an in-plane hard magnetic film whose axis of easy magnetization is generally oriented in the in-plane direction;
wherein the in-plane undercoat film is comprised of a Cr or a Cr alloy; and
the in-plane hard magnetic film comprises one or more than two alloys selected from alloys represented by CoCrPtX (where X is one or more of B, Ta, Cu, Zr, Nb, Re, Ni, Mn, Ge, Si, O, and N).

2. A magnetic recording medium according to claim 1 wherein the magnetic recovery factor of the soft magnetic undercoat film is equal to or greater than 0.85.

3. A magnetic recording medium according to claim 1 wherein the coercive force squareness ratio S* of the in-plane hard magnetic film is equal to or greater than 0.6.

4. A magnetic recording medium according to claim 1 wherein the coercive force Hc of the in-plane hard magnetic film is equal to or greater than 1000 (Oe), the saturated magnetism Ms is equal to or greater than 200 (memu/cm³) and less than 600 (memu/cm³), and the thickness is equal to or greater than 10 nm and less than 100 nm.

5. A magnetic recording medium according to claim 1 wherein the film thickness of the soft magnetic undercoat film is 50 to 200 nm.

6. A manufacturing method for a magnetic recording medium formed on a non-magnetic substrate comprising at least a soft magnetic undercoat film made of a soft magnetic material, an orientation control film for controlling the orientation of the film directly above, a perpendicular magnetic layer whose axis of easy magnetization is generally oriented in the in-plane direction, and a protective layer, the manufacturing method comprises the steps of:
forming in sequence an in-plane undercoat film and an in-plane hard magnetic film whose axis of easy magnetization is generally oriented in the in-plane direction, wherein the in-plane undercoat film is formed by Cr or a Cr alloy, and the in-plane hard magnetic film is formed by a CoCrPtX alloy (where X is one or more of B, Ta, Cu, Zr, Nb, Re, Ni, Mn, Ge, Si, O, or N).

7. A magnetic recording and replay apparatus provided with a magnetic recording medium and a magnetic head that records and replays the information on the magnetic recording medium,
wherein, the magnetic recording medium comprises a non-magnetic substrate, at least a soft magnetic undercoat film comprised of a soft magnetic material, an orientation control film for controlling the orientation of the film directly above, a perpendicular magnetic film whose axis of easy magnetization is generally oriented perpendicular to the substrate, and a protective layer,
wherein an in-plane undercoat film and an in-plane hard magnetic film, whose axis of easy magnetization is generally oriented in the in-plane direction, are formed between the non-magnetic substrate and the soft magnetic undercoat film; and
an in-plane undercoat film comprises Cr or a Cr alloy; and
an in-plane hard magnetic film that incorporates a CoCrPtX alloy (where X is one or more of B, Ta, Cu, Zr, Nb, Re, Ni, Mn, Ge, Si, O, or N).
